(19) United States
(12) Patent Application Publication
(10) Pub. No.: US 2008/0155040 A1
(43) Pub. Date: Jun. 26, 2008

(54) System for preventing spam e-mails and method for performing the same

(76) Inventor: Yun-Nan Chiu, Taipei Hsien (TW)

Correspondence Address: Yun-Nan Chiu, Box 8-24, 235 Chung - Ho, Taipei, omitted

(21) Appl. No.: 11/645,340

(22) Filed: Dec. 26, 2006

(51) Int. Cl. G06F 15/16

(52) U.S. Cl. 709/206

(57) ABSTRACT

A system for preventing spam e-mails comprises a spam mail deleting unit providing a spam e-mail delete table; the spam e-mail deleting table containing a list of selection items which inform the user whether to delete the mail or determine the number of-return-spam mails. The system also comprises a mail accepted unit having a positive table; the positive table having a list of e-mail addresses accepted by a user or a first keyword set in the drift of an e-mail or the title of the mailer of the e-mail which is accepted by the user. The system further has a mail unaccepted unit having a negative table; the negative table having a list of a second keyword set in the drift of an e-mail or a title of the mailer of the e-mail which is not accepted. A method for performing the system is also included.

### FIELD OF THE INVENTION

The present invention relates to spam e-mails, and particularly to a system for preventing spam e-mails and a method for performing the same, wherein by the method of the present invention, the spam e-mail can be prevented effectively, moreover, a mail accepted table and a mail unaccepted table are generated so as to determine whether the mail is necessary to be presented to the user.

### BACKGROUND OF THE INVENTION

Currently, spam e-mails have becomes a great burden to computer users. More and more spam e-mails are sent to the user's mailboxes. Thus, generally, every computer users must take a great time to deal the spam e-mails. For a mail address used for a long time, it is possible that the address has over 200 undesired e-mails accepted in the electronic mailbox. If the user has multiple e-mail addresses, the user must deal several hundreds of mails everyday. Thus the user must take a great deal of time to deal such matters.

It often occurs that the user must delete the spam e-mail, while some desired mails are also deleted unintentionally. Thus spam e-mails have become a serious problem in the application of networks, while for the future, it can predict that this problem will become worse.

Many international committees try to resolve such problems, including United Nation and many international conferences are convened, but until now no effective method is adapted.

### SUMMARY OF THE INVENTION

Accordingly, the primary object of the present invention is to provide a system for preventing spam e-mail and the method for performing the same, wherein by the method of the present invention, the spam e-mail can be prevented effectively, moreover, a mail accepted table and a mail unaccepted table are generated so as to determine whether the mail is needed to be presented to the user effectively.

To achieve above object, the present invention provides a system for preventing spam e-mail. The system comprises a spam mail deleting unit providing a spam e-mail delete table; the spam e-mail deleting table containing a list of selection items which inform the user whether to delete the mail or determine the number of return-spam mails which will be returned to the mailer. The system also comprises a mail accepted unit having a positive table; the positive table having a list of e-mail addresses accepted by a user or a first keyword set in the drift of an e-mail or the title of the mailer of the e-mail which is accepted by the user. The system further has a mail unaccepted unit having a negative table; the negative table having a list of a second keyword set in the drift of an e-mail or a title of the mailer of the e-mail which is not accepted by the user.

Furthermore the present invention further provides a method for determining and deleting spam e-mails. The method comprises the steps of: displaying a spam mail deleting table having a list of selection items which inform the user whether to delete the mail or determine the number of return-spam mails which will be returned to the mailer. The method also contains the step of generating a positive table having a list of e-mail addresses accepted by a user or a first keyword set in the drift of an e-mail or the title of the mailer of the e-mail which is accepted by the user; wherein the mail servo receives a mail, the mail accepted unit will check. The present invention further comprises the steps of generating a negative table having a list of a second keyword set in the drift of an e-mail or a title of the mailer of the e-mail which is not accepted by the user.

The various objects and advantages of the present invention will be more readily understood from the following detailed description when read in conjunction with the appended drawing.

### BRIEF DESCRIPTION OF THE DRAWINGS

FIGS. 1(A), 1(B) and 1(C) show the system of the present invention.

FIG. 2 shows the process of the present invention.

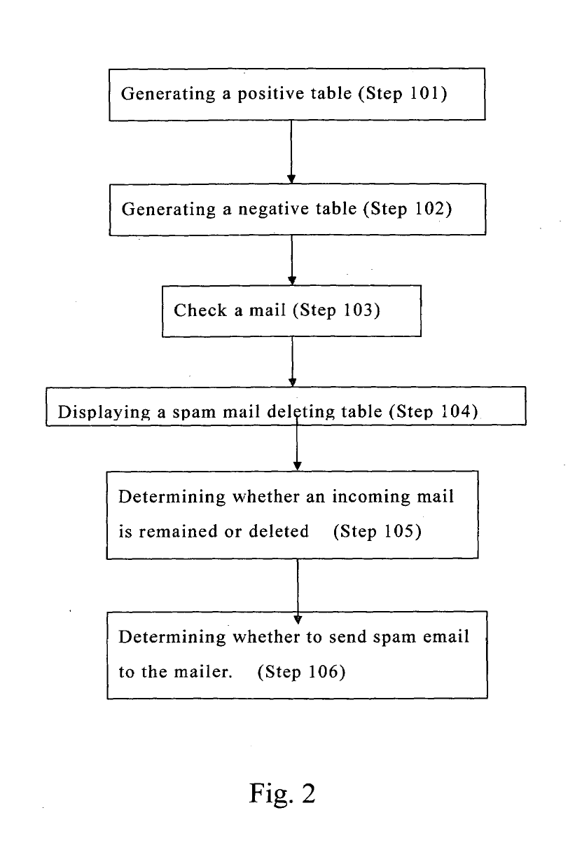

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

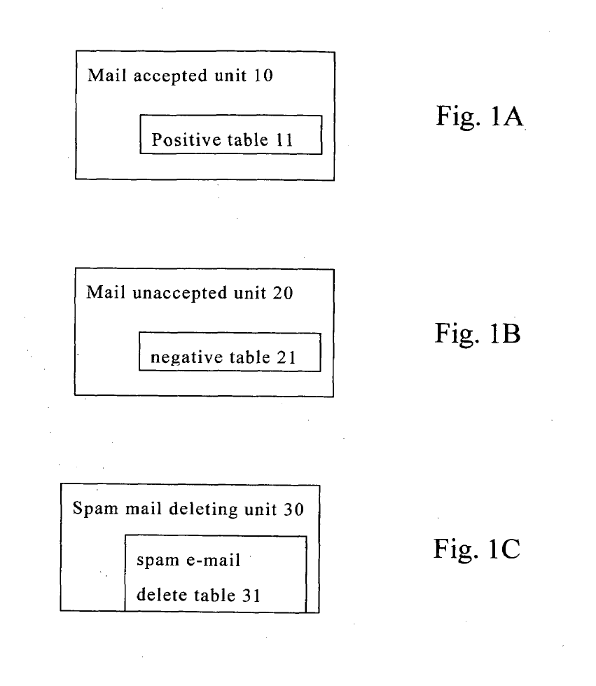

With reference to FIGS. 1(A), 1(B) and 1(C), the system for preventing spam mails (i.e. undesired E-mail from computer network) is disclosed in the present invention. The system of the present invention has the following elements.

A mail accepted unit 10 has a positive table 11. The positive table has a list of e-mail addresses accepted by a user or a first keyword set in the drift of an e-mail or the title of the mailer of the e-mail which is accepted by the user. The mail servo receives a mail, it will check whether the mail is matched to the conditions of the list of the positive table 11; if it is matched to the positive table 11, the e-mail is acceptable and is presented in the mailbox of a user's computer.

A mail unaccepted unit 20 has a negative table 21. The negative table has a list of a second keyword set in the drift of an e-mail or a title of the mailer of the e-mail which is not accepted by the user; wherein when the mail servo receives a mail, it will check whether the mail is matched to the conditions of the list of the negative table. If it is matched to the list of the table, the mail will be determined as a spam e-mail; and the spam is deleted automatically or is stored in a spam mail directory.

A spam mail deleting unit 30 provides a spam e-mail delete table 31. The spam e-mail deleting table containing a list of selection items which inform the user whether to delete the mail or determine the number of return-spam mails which will be returned to the mailer; the spam mail deleting unit generating the number of the return-spam mails and returning these return-spam mails to the mailer who sends the spam e-mail.

For example, if a user finds that a mail is a spam e-mail and determines to delete the mail, the user can click a delete item or a key on a keyboard or on a mouse, then the spam mail deleting table is displayed to the user. The table has an item of “delete the mail and do not response to the mail”, and an item of “delete the mail and response to the mail with sending 100 spam mails to the mailer” (the number is selectable by the user). Thus, if the user clicks a desired item, for example, the latter item is selected, then the spam mail is deleted and 100 other spam mails are sent to the mailers of the incoming spam mail and re-sending a plurality of spam e-mails to the mailer.

The present invention further comprises the function of auto-registration of the incoming spam e-mail to the negative table, that is, if a mail is deleted, then the address of the mailer will be registered on the negative table. Thus in the future, the e-mails from the mailer will be deleted automatically.

The present invention further comprises a function of auto-registration of incoming accepted mails to the positive table. That is, if the incoming mail is accepted by the users, the address of the e-mail is registered on the positive table. Thereby the e-mails from the mailers accepted will not be automatically deleted.

Thus it is seen that by the use of the present invention, the user can eliminate most undesired e-mails so as to reduce the burden in the process of the e-mails.

The process of the present invention will be described herein with reference to FIG. 3. The process includes the steps of:

Generating a positive table (Step 101) having a list of e-mail addresses accepted by a user or a first keyword set in the drift of an e-mail or the title of the mailer of the e-mail which is accepted by the user; wherein the mail servo receives a mail, it will check whether the mail is matched to the conditions of the list of the positive table; if it is matched to the positive table, the e-mail is acceptable and is presented in the mailbox of a user's computer.

Generating a negative table (Step 102) having a list of a second keyword set in the drift or title of a mailer of an e-mail which is not accepted by the user.

When the mail servo receives a mail, the mail servo checks whether the mail is matched to the conditions of the list of the positive table, wherein if it is not matched to the list of the table, the mail will be determined as a spam e-mail.

When the mail servo receives a mail, it will check whether the mail is matched to the conditions of the list of the negative table, wherein if it is matched to the list of the table, the mail will be determined as a spam e-mail (Step 103)

Displaying a spam mail deleting table (Step 104) having a list of selection items which inform the user whether to delete the mail or determine the number of mails which will be returned to the mailer.

Responding the user's selection, if the user determines to remain the incoming e-mail, the e-mail is retained; if the user determine to delete the incoming e-mail, the e-mail will be deleted (Step 105); and if the user determines to respond the e-mail with a plurality of spam e-mails to the mailer, the system will send a plurality of spam e-mails with a predetermined number to the mailer (Step 106).

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A system for preventing spam e-mail comprising:
a spam mail deleting unit providing a spam e-mail delete table; the spam e-mail deleting table containing a list of selection items which inform the user whether to delete a spam mail or determine the number of returning-spam mails which will be returned to a mailer mailing the spam mail; the spam mail deleting unit generating the returning-spam mails with the determined number and returning these returning-spam mails to the mailer who sends the spam e-mail.

2. The system for preventing spam e-mail as claimed in claim 1, further comprising;
a mail accepted unit having a positive table; the positive table having a list of e-mail addresses accepted by a user or a first keyword set in the drift of an e-mail or the title of the mailer of the e-mail which is accepted by the user; wherein the mail servo receives a mail, the mail accepted unit will check whether the mail is matched to the conditions of the list of the positive table; if it is matched to the positive table, the e-mail is acceptable and is presented in the mailbox of a user's computer; and if it is not matched to the list of the table, the mail will be determined as a spam e-mail.

3. The system for preventing spam e-mail as claimed in claim 1, further comprising:
a mail unaccepted unit having a negative table; the negative table having a list of a second keyword set in the drift of an e-mail or a title of the mailer of the e-mail which is not accepted by the user; wherein when the mail servo receives a mail, it will check whether the mail is matched to the conditions of the list of the negative table; if it is matched to the list of the table, the mail will be determined as a spam e-mail; and the spam e-mail is deleted automatically or is stored in a spam mail directory.

4. A method for determining and deleting spam e-mails, comprising the steps of:
in response to a designation of deleting a mail, displaying a spam mail deleting table having a list of selection items which inform the user whether to delete the mail or determine the number of returning-spam mails which will be returned to the mailer with a great amount of spam mails;
in response to the user's selection, if the user determines to remain the incoming e-mail, the e-mail is retained; if the user determines to delete the incoming e-mail, the e-mail will be deleted; and if the user determines to respond the e-mail with a plurality of return-spam e-mails to the mailer, the system will send a plurality of return-spam e-mails with a predetermined number to the mailer.

5. The method for determining and deleting spam e-mails as claimed in claim 4, further comprising steps of:
generating a positive table having a list of e-mail addresses accepted by a user or a first keyword set in the drift of an e-mail or the title of the mailer of the e-mail which is accepted by the user; wherein the mail servo receives a mail, the mail accepted unit will check whether the mail is matched to the conditions of the list of the positive table; if it is matched to the positive table, the e-mail is accepted and is presented in the mailbox of a user's computer; and if it is not matched to the list of the table, the mail will be determined as a spam e-mail.

6. The method for determining and deleting spam e-mails as claimed in claim 4, further comprising steps of:
generating a negative table having a list of a second keyword set in the drift of an e-mail or a title of the mailer of the e-mail which is not accepted by the user; wherein when the mail servo receives a mail, it will check whether the mail is matched to the conditions of the list of the negative table; if it is matched to the list of the table, the mail will be determined as a spam e-mail; and the spam is deleted automatically or is stored in a spam mail directory.

7. The method for determining and deleting spam e-mails as claimed in claim 6, further comprising steps of: when an e-mail is deleted, the address of the e-mail is registered in the negative table.

8. The method for determining and deleting spam e-mails as claimed in claim 5, further comprising steps of: when an e-mail is accepted, the address of the e-mail is registered in the positive table.
